(19) United States
(12) Patent Application Publication
(10) Pub. No.: US 2009/0046961 A1
(43) Pub. Date: Feb. 19, 2009

(54) THRUST PLATE, HYDRODYNAMIC BEARING DEVICE, SPINDLE MOTOR, AND INFORMATION APPARATUS EQUIPPED WITH SAME; AND METHOD FOR MANUFACTURING THRUST PLATE

(76) Inventors: Akihiko Wakitani, Ehime (JP); Keigo Kusaka, Ehime (JP)

Correspondence Address: WENDEROTH, LIND & PONACK L.L.P., 2033 K. STREET, NW, SUITE 800, WASHINGTON, DC, 20006, US

(21) Appl. No.: 12/179,024

(22) Filed: Jul. 24, 2008

(30) Foreign Application Priority Data
Jul. 27, 2007 (JP) 2007-196680

(51) Int. Cl. F16C 32/06; B21D 53/10

(52) U.S. Cl. 384/121; 29/898.02

(57) ABSTRACT

There are provided a thrust plate with which there is less warpage when the thrust plate has been incorporated into a hydrodynamic bearing device, which improves the reliability of the hydrodynamic bearing device, as well as a hydrodynamic bearing device, a spindle motor, and an information apparatus equipped with this thrust plate, and a method for manufacturing a thrust plate.

With a thrust plate that is provided at one end of a shaft of a hydrodynamic bearing device and that closes off one end of a sleeve formed so as to surround the shaft via a lubricating fluid (oil), a laser irradiated portion is provided to the opposite side of the thrust plate from the side facing the shaft in order to reduce the warpage that is produced by the formation of a hydrodynamic groove on the side facing the shaft, and the warpage that occurs during assembly, etc.

### BACKGROUND OF THE INVENTION

1. Field of the Invention

The present invention relates to a thrust plate installed in a hydrodynamic bearing device, and to a hydrodynamic bearing device, a spindle motor, and an information apparatus equipped with this thrust plate, and to a method for manufacturing a thrust plate.

2. Description of the Related Art

Conventional hydrodynamic bearing devices installed in spindle motors and so forth are equipped with a shaft that is mounted in a bearing hole formed in a cylindrical sleeve, with a lubricating fluid (oil) disposed around the outer periphery. A thrust plate is provided at one end of the sleeve to prevent the lubricating fluid from flowing out. Hydrodynamic pressure produced when the lubricating fluid flows into a hydrodynamic groove provided in the thrust plate or the sleeve during rotation causes a member on the rotating side to rotate in a non-contact state around the shaft with respect to a member on the stationary side. With a hydrodynamic bearing device such as this, it is preferable if the characteristics of the rotation mechanism thereof are such that the shaft and the sleeve and thrust plate rotate with a specific gap in between in order to allow the shaft to rotate without runout. Therefore, the surface of the thrust plate disposed opposite the shaft is preferably flat and parallel to the end face of the shaft opposite the thrust plate. That is, if the thrust plate should be warped, the hydrodynamic pressure produced during rotation will not be stable, which can lead to problems such as unstable float height or excessive wear of the contact face.

Particularly when a hydrodynamic groove is formed on the surface of the thrust plate opposite the shaft, internal stress is generated within the thrust plate by the formation of the groove, which is a problem in that it makes the thrust plate more likely to warp. This warpage destabilizes the hydrodynamic pressure generated in the thrust bearing between the mutually opposing thrust plate and shaft, and makes it impossible to maintain proper operation of the hydrodynamic bearing device.

To solve this problem, Patent Document 1 discloses a thrust plate configuration in which a groove is also formed on the opposite face from the face on which the hydrodynamic groove is formed, so as to make the distribution of internal stress more uniform.

Patent Document 1: Japanese Laid-Open Patent Application 2007-32623 (laid open on Feb. 8, 2007)

### SUMMARY OF THE INVENTION

### Problem to be Solved by the Invention

However, the following problem is encountered with the thrust plate configuration disclosed in the above publication.

In a state in which the thrust plate can be processed alone, it is indeed possible to reduce warpage of the thrust plate, but it is impossible to eliminate the warpage that occurs when the thrust plate is mounted by caulking, bonding, etc., to the bottom portion of the hydrodynamic bearing device.

It is an object of the present invention to provide a thrust plate with which there is less warpage when the thrust plate has been incorporated into a hydrodynamic bearing device, which improves the reliability of the hydrodynamic bearing device, as well as a hydrodynamic bearing device, a spindle motor, and an information apparatus equipped with this thrust plate, and a method for manufacturing a thrust plate.

### Means for Solving Problem

The thrust plate pertaining to the first invention is a thrust plate included in a hydrodynamic bearing device, which is provided at one end of a shaft and substantially perpendicular to the axial direction of the shaft. This thrust plate includes a laser irradiated portion on the opposite side from the side facing the shaft.

Here, for example, with a thrust plate that is provided at one end of a shaft of a hydrodynamic bearing device and that closes off one end of a sleeve formed so as to surround the shaft via a lubricating fluid (oil), the following configuration is employed in order to reduce the warpage that is produced by the formation of a hydrodynamic groove on the side facing the shaft, and the warpage that occurs during assembly, etc. More specifically, the laser irradiated portion is provided on the opposite side of the thrust plate from the side facing the shaft.

The shaft here is a rod-shaped shaft provided at the rotational center position of the hydrodynamic bearing device. The laser irradiated portion is a region that has been worked by laser forming, for example. Laser forming is a technique by which a metal sheet is bent by thermal strain in the region irradiated by a laser without contact and without being affected by spring-back. The laser irradiated portion may also be a region worked by laser marking. Laser marking is a technique for marking an irradiated object by using a laser beam to melt the surface of the irradiated object or to bake on an ink.

When a configuration such as this is used, even if the thrust plate should warp during assembly of the hydrodynamic bearing device, the warpage that occurs in the thrust plate can be reduced by forming a laser irradiated portion at the part of the thrust plate exposed on the outside of the hydrodynamic bearing device.

Therefore, a constant gap can be maintained between the mutually opposing shaft and thrust plate, and the hydrodynamic pressure generated during rotation of the hydrodynamic bearing device can be stabilized. As a result, problems such as runout or excessive wear of the contact portions caused by uneven or unstable generation of hydrodynamic pressure can be prevented, while the reliability and service life of the hydrodynamic bearing device equipped with the thrust plate can be improved.

The thrust plate pertaining to the second invention is the thrust plate pertaining to the first invention, wherein the laser irradiated portion is formed by irradiation with a plurality of laser spots.

Here, the laser irradiated portion is formed by performing spot laser irradiation at a plurality of locations.

The irradiation diameter of the laser here can be controlled by providing the laser generator with a focusing mechanism. That is, “spot irradiation” is laser irradiation in which the irradiation diameter is limited. The irradiated diameter produced by spot irradiation can also be controlled by adjusting the distance between the laser generator and the object being irradiated. The laser irradiation output and other such irradiation conditions can be controlled by adjusting the current, voltage, etc., of the laser generator.

As a result, the individual spot irradiated portions (regions of spot irradiation) formed locally are formed by the individual irradiation conditions for each spot irradiated portion, which makes it possible to smooth out fine irregularities (local warpage) on the thrust plate.

As a result, it is possible to obtain a thrust plate that is flatter than that obtained with a single laser irradiation.

The thrust plate pertaining to the third invention is the thrust plate pertaining to the first or second invention, wherein the laser irradiated portion is provided substantially in the center.

Here, the laser irradiated portion is provided near the center of the laser irradiation face.

Warpage of the thrust plate tends to be much more pronounced near the center of the thrust plate, depending on the hydrodynamic groove formation region and its shape, how the thrust plate is attached to the hydrodynamic bearing device, and so forth.

Therefore, warpage can be efficiently reduced since the laser irradiation is concentrated in the region where warpage of the thrust plate is most pronounced.

As a result, the laser irradiation position is limited to within a preset region, which makes it possible to obtain a thrust plate with more effectively reduced warpage.

The thrust plate pertaining to the fourth invention is the thrust plate pertaining to the any of the first to third inventions, wherein the laser irradiated portion is formed as an identification code for the hydrodynamic bearing device into which this thrust plate is incorporated, for example.

Here, the laser irradiated portion serves the role of an identification code. For instance, an identification code for the thrust plate is formed by laser marking.

The identification code here may be, for example, a QR code (registered trademark), Code 49, Code 16K, PDF417, Ultra Code, Data Matrix, Veri Code, Maxi Code, CP Code, Code 1, Box Graphic Code, Aztech Code, or the like. It may also be a barcode (such as JAN, ITF, Code 39, NW-7, or Code 128).

As a result, a code expressing the lot number can be easily formed on the face of the thrust plate after assembly of the hydrodynamic bearing device. Also, since an identification code can be engraved by laser irradiation without coming into contact with the thrust plate, no material is wasted and there is no need for ink or other such materials.

Therefore, throughput can be increased and cost reduced in the manufacturing process.

The thrust plate pertaining to the fifth invention is the thrust plate pertaining to the fourth invention, wherein the identification code is a QR code (registered trademark).

Here, a QR code is formed as the identification code formed on the surface of the thrust plate on its exposed side.

The QR (Quick Response) code here is a matrix-type two-dimensional code in which microdots are arranged in rows and columns. This QR code allows the recording of many kinds of character information, such as Japanese kana and kanji, numbers or alphabetic letters.

As a result, an identification number such as a lot number or model number of the thrust plate or of the hydrodynamic bearing device in which the thrust plate is installed can be engraved in detail by laser irradiation.

Also, with a QR code, since there is redundancy in the information, if part of the QR code has been damaged or soiled and cannot be read, it is possible to restore this information from another region. Therefore, even if the surface of the thrust plate should be soiled or shaved off, it will still be possible to read the identification code at a higher probability than in the past.

The hydrodynamic bearing device pertaining to the sixth invention is equipped with the thrust plate according to any of the first to fifth inventions.

Here, the above-mentioned thrust plate is installed in a hydrodynamic bearing device.

As a result, the hydrodynamic pressure generated via the lubricating fluid in the thrust bearing formed between the mutually opposing thrust plate and shaft can be stabilized and runout reduced. Therefore, a hydrodynamic bearing device can be obtained with higher reliability and a longer service life.

The spindle motor pertaining to the seventh invention is equipped with the hydrodynamic bearing device pertaining to the sixth invention.

Here, the above-mentioned hydrodynamic bearing device is installed in a spindle motor.

As a result, the same effect as above can be obtained, namely, that the hydrodynamic pressure generated in the thrust bearing formed between the thrust plate and the shaft can be stabilized, which makes it possible to obtain a spindle motor that vibrates less and is quieter. Also, since this spindle motor has less energy conversion loss, it is possible to obtain a spindle motor that is more energy efficient.

The information apparatus pertaining to the eighth invention is equipped with the spindle motor pertaining to the seventh invention.

Here, the above-mentioned spindle motor is installed in an information apparatus such as an magneto-optical recording and reproduction apparatus.

As a result, an information apparatus can be obtained that is more reliable and operates more quietly.

The method for manufacturing a thrust plate pertaining to the ninth invention is a method for manufacturing a thrust plate that is provided at one end of a shaft included in a hydrodynamic bearing device and substantially perpendicular to the axial direction of the shaft, said method having a first step of inspecting the state of warpage of the thrust plate, and a second step of irradiating the thrust plate with a laser. The laser irradiation position in the second step is a position corresponding to the warpage, which was ascertained in the first step, on the opposite side of the thrust plate from the side facing the shaft.

Here, a first step of inspecting the state of warpage of the thrust plate and a second step of irradiating the thrust plate with a laser at a position corresponding to the warpage.

The shaft here is a rod-shaped shaft provided at the rotational center position of the hydrodynamic bearing device, for example. Laser irradiation refers to laser forming, for example. Laser forming is a technique by which a metal sheet is bent without contact and without being affected by spring-back caused by thermal strain in the region irradiated by a laser. The laser irradiation may also be laser marking. Laser marking is a technique for marking an irradiated object by using a laser beam to melt the surface of the irradiated object or to bake on an ink.

This method allows warpage of the thrust plate to be reduced even after the thrust plate has been incorporated into a hydrodynamic bearing device. Also, even with a configuration in which the hydrodynamic groove is formed on the thrust plate side, warpage of the thrust plate attributable to internal stress produced by the formation of the groove can be reduced at the same time.

Therefore, a constant gap can be maintained between the mutually opposing shaft and thrust plate, and the hydrodynamic pressure generated during rotation of the hydrodynamic bearing device equipped with the thrust plate can be stabilized. As a result, the reliability and service life of the hydrodynamic bearing device equipped with the thrust plate can be improved.

The method for manufacturing a thrust plate pertaining to the tenth invention is the method for manufacturing a thrust plate pertaining to the ninth invention, wherein the laser irradiation is performed by a plurality of spot irradiations in the second step.

The irradiation diameter of the laser here can be controlled by providing the laser generator with a focusing mechanism, and “spot irradiation” is laser irradiation in which the irradiation diameter is limited. The irradiated diameter can also be controlled by adjusting the distance between the laser generator and the object being irradiated. The laser irradiation conditions can be controlled by adjusting the current, voltage, etc., of the laser generator.

Here, the laser irradiation includes irradiation with a plurality of laser spots.

Because of this, the irradiation conditions for each of the local irradiation spots can be individually set, which affords greater latitude in laser forming and a broader range of adjustment extent.

As a result, a thrust plate with a high degree of flatness can be formed precisely.

The method for manufacturing a thrust plate pertaining to the eleventh invention is the method for manufacturing a thrust plate pertaining to the ninth or tenth invention, wherein control is performed in the second step by at least one of the output of the laser, the spot diameter of the laser, and the irradiation time of the laser.

Here, the laser output, its spot diameter, and its irradiation time are controlled. With a given laser generation device, the output of the laser can be adjusted by means of the voltage or current applied to the laser generation device. The spot diameter can be adjusted by means of the distance between the laser emission location and the irradiated object, or an optical lens.

This makes possible the fine control of the region of high temperature and the temperature gradient in laser forming.

Therefore, a manufacturing method can be obtained which is able to meet the need for high working precision with respect to warpage that occurs in the thrust plate.

### EFFECTS OF THE INVENTION

With the thrust plate pertaining to the present invention, the generation of warpage when the thrust plate has been incorporated into a hydrodynamic bearing device is suppressed, which allows the reliability of the hydrodynamic bearing device to be improved.

### DETAILED DESCRIPTION OF THE INVENTION

A HDD (information apparatus) 9 including a spindle motor 8 equipped with a bearing (hydrodynamic bearing device) 7 that includes a thrust plate 4 pertaining to an embodiment of the present invention will now be described through reference to FIGS. 1 to 6.

Overall Configuration of HDD 9

As shown in FIG. 1, the HDD 9 pertaining to this embodiment includes in its interior a plurality of recording and reproducing heads 10, and is equipped with the spindle motor 8. The recording and reproducing heads 10 write information to a recording disk D serving as a recording medium, or reproduce information that has previously been written.

The disk D is a disk-shaped recording medium whose diameter attached to the HDD 9 is 0.85 inch, 1.0 inch, 1.8 inches, 2.5 inches, or the like.

The spindle motor 8 is a device that serves as a rotational drive source for rotationally driving the recording disk D, and mainly includes a rotor magnet 17, a stator coil 18, a stator core 19, a magnetic shield plate 11, a base 15, a rotor hub 16, the bearing 7, etc.

Description of Members Constituting Spindle Motor 8

The rotor magnet 17 is an annular member in which adjacent magnetic poles are alternately disposed as N poles and S poles. For instance, it is made up of an Nd—Fe—B-based resin magnet or the like, and is mounted on a magnet holder of the rotor hub 16.

The stator core 19 has a plurality of protruding poles disposed at substantially equiangular spacing in the radial direction. The stator coil 18 is wound around each of these protruding poles. The stator core 19 imparts rotational force to the rotor magnet 17 by imparting to the rotor magnet 17, which is disposed opposite the inside diameter side in the radial direction, a magnetic flux generated by the flow of current to the stator coil 18.

The magnetic shield plate 11 is attached so as to cover the upper part of the stator coil 18 and the stator core 19, and is made of magnetic stainless steel having a thickness of approximately 0.1 mm in order to prevent magnetic leakage to the outside.

The base 15 is formed from steel sheet or magnetic stainless steel, and is subjected to electroless nickel plating to constitute a portion on the stationary side of the spindle motor 8. The bearing 7 is fixed near the center portion of the base 15. The base 15 may also be formed from an aluminum alloy.

The rotor hub 16 is formed from a magnetic stainless steel material (such as DHS1), and is fixed so as to mate with the upper end part of a shaft 1 (discussed below) and rotates integrally with the shaft 1. The rotor hub 16 has a center hole into which the upper end part of the shaft 1 is inserted, a magnet holder to which the rotor magnet 17 is attached, and a disk placement face on which the recording disk D is placed.

The bearing 7 is a hydrodynamic bearing device included in the spindle motor 8, and is disposed near the center part of the spindle motor 8.

Description of Members Constituting Bearing 7

As shown in FIG. 2, the bearing 7 mainly includes the shaft 1, a sleeve 2, a thrust flange 3, the thrust plate 4, a cover 5, etc.

The shaft 1 is a member that serves as the rotating shaft of the bearing 7, is inserted into a bearing hole 2a in the sleeve 2, and is made of stainless steel (such as SUS 420), high-strength steel (ASK 8000), etc.

The sleeve 2 supports the thrust flange 3 and the shaft 1 inserted in the bearing hole 2a in a state of being relatively rotatable. A thrust hydrodynamic groove (not shown) for generating hydrodynamic pressure is formed on the face of the thrust flange 3 that is opposite the thrust plate 4 in the axial direction, and a thrust hydrodynamic pressure generator is formed between the thrust flange 3 and the thrust plate 4. Similarly, a radial hydrodynamic groove (not shown) for generating hydrodynamic pressure is formed between the opposing faces (in the radial direction) of the thrust flange 3 and the thrust plate 4, and a radial hydrodynamic pressure generator for generating hydrodynamic pressure is formed between the shaft 1 and the sleeve 2. Also, the bearing 7 without the thrust flange 3 may be used. The sleeve 2 is formed from brass or another such copper alloy, and its surface is subjected to electroless nickel plating. The sleeve 2 has a communicating hole 6 that allows a closed end 2ab on the thrust plate 4 side in the axial direction to communicate with an open end 2aa on the opposite side. The cover 5 is attached on the open end 2aa side of the sleeve 2 so as to form a specific gap between itself and the upper end face of the sleeve 2. The sleeve 2 may also be formed from an iron-based material or a sintered material.

The thrust flange 3 is fixed to the shaft 1 by integral working or by press-fitting or adhesive bonding, and is formed from stainless steel (such as SUS 304 and SUS 420). The thrust flange 3 is mated with a large-diameter hole 2ac of the sleeve 2.

The thrust plate 4 is attached to the lower end face of the sleeve 2 in the axial direction (the bottom portion of the bearing 7), and forms the closed end of the sleeve 2. The configuration of the thrust plate 4 will be described in detail at a later stage.

The cover 5 is a substantially disk-shaped member attached so as to cover the upper end face of the sleeve 2 (the open end 2aa side), and has an open portion in its center into which the shaft 1 is inserted.

In this embodiment, of the constituent members discussed above, an inner peripheral seal 12 is formed on the outer peripheral face side of the shaft 1, which is the gap portion formed between the cover 5 and the end face on the open end 2aa side in the axial direction of the sleeve 2. As a result, a lubricating fluid (oil) 20 that fills the bearing 7 exerts an attractive force on the interior of the bearing 7 by capillary action, and this prevents leakage to the outside from an inner peripheral opening 5a. A low viscosity ester-based oil or the like can be used as the oil 20.

Configuration of Thrust Plate 4

As discussed above, the thrust plate 4 is provided so as to form the closed end 2ab of the sleeve 2, and is a substantially disk-shaped member. A side end 45 of the thrust plate 4 is latched and fixed by a latching portion 21 provided on the closed end 2ab side of the sleeve 2.

This thrust plate 4 is formed from a martensite-based stainless steel that is easier to harden by quenching, such as SUS 420J2 (JIS). Also, as shown in FIG. 3A, a herringbone-shaped hydrodynamic groove 44 is formed in a face 41 of the thrust plate 4 that is opposite the thrust flange 3. As shown in FIG. 3B, a laser irradiated portion 43 formed by laser irradiation is provided near the center of a face 42 on the opposite side from the face 41 in which the hydrodynamic groove 44 is formed. The face 42 of the thrust plate 4 in which the laser irradiated portion 43 is formed is in a state of being exposed to the outside at the bottom portion of the spindle motor 8.

As shown in FIG. 3B, the laser irradiated portion 43 is formed by a plurality of spot irradiations of laser near the center of the face 42 of the thrust plate 4. The spot irradiated portions 43a formed by these spot irradiations are in the form of dots with a diameter of approximately 5 μm.

The hydrodynamic groove may also be formed on the surface of the thrust flange 3 and the shaft 1.

Method for Manufacturing Thrust Plate 4

The thrust plate 4 in this embodiment is manufactured by the manufacturing process illustrated in the flowchart of FIG. 4.

First, in step S1, a blank is formed for the thrust plate 4. This blank can be formed by using a press to punch out the above-mentioned material (SUS 420J2) in the form of a disk, and then heat treat and polish the surface of this disk.

Then, in step S2, the hydrodynamic groove 44 is formed on the face 41, which is one of the faces of the disk-shaped blank obtained in step S1. This hydrodynamic groove 44 can be formed by first coating the surface of the face 41 with a resist. After the resist has been dried and cured, exposure and developing are performed by photolithography. After this, a position corresponding to a recessed portion 44a of the hydrodynamic groove 44 is etched down to the desired depth, and the resist is peeled off. The hydrodynamic groove 44 shown in FIG. 3A is formed in this manner. This step can be omitted if a hydrodynamic groove is formed on the shaft side.

Then, in step S3, the thrust plate 4 obtained in step S2 is incorporated at one end of the sleeve 2 (the closed end 2ab). Here, as shown in FIGS. 5A and 5B, the side end 45 of the thrust plate 4 is latched (crimped) by the latching portion 21 provided to the end of the sleeve 2.

Here, as shown in FIG. 6, warpage occurs in the thrust plate 4 that has undergone steps S1 to S3, caused, for example, by internal stress produced by the formation of the hydrodynamic groove 44, or external force imparted during fixing to the sleeve 2. In view of this, the thrust plate 4 is subjected to laser irradiation in the following step in order to eliminate or reduce warpage of the thrust plate 4 produced in the steps so far.

In step S4, the thrust plate 4 attached to the sleeve 2 is inspected for warpage or bumpiness. More specifically, warpage of the thrust plate 4 is measured using a laser focusing type of displacement sensor (laser focusing displacement gauge).

In step S5, laser forming is performed by spot irradiations of laser on the basis of the measurement results obtained in step S4, which reduces the warpage of the thrust plate 4. The conditions for the spot irradiation here are, for example, such that the output of the semiconductor laser that generates the laser beam is 3800 W (voltage of 200 V and current of 19 A), the spot diameter on the thrust plate 4 surface is 5 μm, and the irradiation time is 0.004 second per spot. Naturally, the laser device used here can be controlled for irradiation diameter and laser output (spot irradiation), and the laser irradiation locations, the number of irradiated spots, the irradiation time, and so forth can also be controlled.

The principle of laser forming will now be described briefly. First, the thrust plate is locally heated by laser irradiation, and since this heating time is extremely short, a temperature gradient is produced around the laser irradiated portion. This temperature gradient is also accompanied by a difference in the expansion rate. Also, since a difference in the decrease in yield stress is also produced at the same time, the region between the region of high temperature and the region of low temperature undergoes plastic deformation. If the temperature gradient is eliminated (if the temperature is brought back to room temperature), the expanded region contracts, and as a result the thrust plate 4 deforms so that the face on the laser irradiated side becomes concave.

By going through the above steps S1 to S5, it is possible to form a flat thrust plate 4 by performing laser irradiation from outside the device even after incorporation into the bearing 7.

### WORKING EXAMPLE 1

The flatness before and after forming the laser irradiated portion 43 (the spot irradiated portions 43a) on the thrust plate 4 in this embodiment was measured, the results of which will be given below. The term “flatness” here is the minimum value of a distance t in a state in which an object is sandwiched between two parallel flat faces that are separated by this distance t. The thrust plate 4 used in the measurement was in the form of a disk with a diameter of approximately 6.5 mm and a thickness of 0.45 mm.

First, before the formation of the laser irradiated portion 43, that is, in the state prior to subjecting the thrust plate 4 to laser forming, the flatness was 0.66 μm. The thrust plate 4 was then subjected to laser forming. The irradiation conditions in the laser forming included an output of 3800 W, an irradiation time of 0.004 second per spot, and an irradiation (spot) diameter of 5 μm. Laser forming conducted under these conditions changed the flatness of the thrust plate 4 to 0.20 μm.

That is, the flatness improved by 0.46 μm before and after laser forming.

Thus, this embodiment shows that flatness on the sub-micrometer level can be achieved. Therefore, compared to a mechanical flattening method, the thrust plate 4 can be obtained in a better parallel flat plane state at high precision.

Features of Thrust Plate 4

(1)

As shown in FIG. 3B, the thrust plate 4 pertaining to this embodiment includes the laser irradiated portion 43 produced by laser forming on the face 42 on the opposite side of the thrust plate 4 from the face 41 that faces the shaft 1 (the thrust flange 3).

Consequently, even after assembly of the bearing 7, the warpage that occurs in the thrust plate 4 can be reduced by irradiating the part of the thrust plate 4 exposed on the outside with a laser. As a result, a constant gap can be maintained between the thrust plate 4 and the shaft 1 including the thrust flange 3, and the hydrodynamic pressure generated during rotation of the bearing 7 can be stabilized. Also, since laser forming is a non-contact working method, the thrust plate 4 is not scratched nor affected by spring-back. As a result, since runout of the center of rotation does not occur, this has a smoothing effect on external turbulence, allowing a bearing 7 with higher reliability to be obtained.

(2)

As shown in FIG. 3B, the thrust plate 4 pertaining to this embodiment includes a plurality of spot irradiated portions 43a formed by a plurality of spot irradiations of laser on the face 42.

Consequently, the spot irradiated portions 43a formed locally are formed with the individual irradiation conditions for each spot irradiated portion 43a, which makes it possible to smooth out local warpage and warpage that is not simple (complex warpage). As a result, it is possible to obtain a thrust plate 4 that is flatter than that obtained with a single laser irradiation.

(3)

As shown in FIG. 3B, the thrust plate 4 pertaining to this embodiment includes the laser irradiated portion 43 near the center of the face 42.

Consequently, warpage that occurs when external force is imparted during attachment to the sleeve 2, warpage caused by internal stress produced by the hydrodynamic groove 44 formed substantially near the center of the face on the opposite side, or other such warpage can be effectively reduced by forming the laser irradiated portion 43 in the region where warpage of the thrust plate 4 is most pronounced.

(4)

As shown in FIG. 2, the bearing 7 pertaining to this embodiment is equipped with the above-mentioned thrust plate 4.

Consequently, as discussed above, no runout is generated in the rotational center, and a bearing 7 can be obtained with high reliability and a good smoothing effect on external turbulence.

(5)

As shown in FIG. 1, the spindle motor 8 pertaining to this embodiment is equipped with the above-mentioned bearing 7 as a hydrodynamic bearing device.

Consequently, as discussed above, no runout is generated in the rotational center, and a spindle motor 8 can be obtained with high reliability and a good smoothing effect on external turbulence.

(6)

As shown in FIG. 1, the HDD 9 pertaining to this embodiment is equipped with the above-mentioned spindle motor 8.

Consequently, as discussed above, no runout is generated in the rotational center, and a HDD 9 can be obtained with high reliability and a good smoothing effect on external turbulence.

(7)

As shown in FIG. 4, the method for manufacturing the thrust plate 4 pertaining to this embodiment includes a step S4 in which the warpage of the thrust plate 4 is measured, and a step S5 in which spot irradiation with a laser at positions corresponding to the warpage is performed in order to reduce the warpage.

Consequently, even after the thrust plate 4 has been incorporated into the bearing 7, warpage of the thrust plate 4 can be reduced, and warpage of the thrust plate 4 caused by internal stress produced by the formation of the hydrodynamic groove 44 can be reduced at the same time.

Therefore, as a result of the above-mentioned reduction in warpage of the thrust plate 4, hydrodynamic pressure is stabilized during rotation of the bearing 7, and a constant gap can be maintained between the shaft and thrust plate. As a result, the reliability and service life of the bearing 7 equipped with the thrust plate 4 can be improved.

(8)

The method for manufacturing the thrust plate 4 pertaining to this embodiment is such that in step S5, laser irradiation is performed by means of a plurality of spot irradiations of laser.

Consequently, the irradiation conditions for each of the local irradiation spots can be individually set, which affords greater latitude in laser forming and a broader range of adjustment extent.

As a result, a thrust plate 4 with a high degree of flatness can be formed precisely.

(9)

The method for manufacturing the thrust plate 4 pertaining to this embodiment is such that in step S5, the laser irradiation conditions include an output of 3800 W, a spot diameter of 5 μm, and an irradiation time of 0.004 second per spot.

Consequently, this makes possible the fine control of the region of high temperature and the temperature gradient in laser forming. Therefore, a manufacturing method can be obtained which is able to meet the need for high working precision with respect to warpage that occurs in the thrust plate 4.

As discussed above, with this embodiment, even after assembly of the bearing 7, warpage of the thrust plate 4 can be reduced by planar irradiation to the thrust plate 4 with a laser. That is, the thrust plate 4 can be actively deformed in the opposite direction from the warpage direction. Therefore, warpage produced by the formation of the hydrodynamic groove 44, attachment to the sleeve 2, or the like can be reduced all at once. Also, it is possible to change the laser irradiation position appropriately. Accordingly, the positions corresponding to portions where warpage occurs can be selectively irradiated with a laser after taking into account the extent and place of the warpage. As a result, micro-deformation or local deformation can be performed, allowing warpage to be eliminated more precisely than in the past.

### OTHER EMBODIMENTS

Preferred embodiments of the present invention were described above, but the present invention is not limited to or by the above-mentioned embodiments, and various modifications are possible without departing from the gist of the present invention.

(A)

In the above-mentioned embodiments, as shown in FIG. 3B, the spot irradiation locations were described as being near the center of the thrust plate 4, but the present invention is not limited to this.

For instance, rather than near the center, laser spot irradiation may be performed at the places where warpage occurs in the thrust plate 4, or in a region of a high extent of warpage. That is, as shown in FIG. 7A, when the warpage occurs locally, or, as shown in FIG. 7B, when the center of warpage is offset, for example, the laser spot irradiation is performed at locations corresponding to the shape of this warpage.

Consequently, warpage can be reduced even when this warpage occurs somewhere other than near the center of a thrust plate. Therefore, this affords greater flexibility even for warpage somewhere else than near the center, which occurs as a result of something other than the formation of the hydrodynamic groove 44 or attachment of the thrust plate 4 to the sleeve 2, and makes it possible for a flat thrust plate 4 to be obtained at all times.

There is no need for the spot irradiation positions to be positions corresponding to the warpage of the thrust plate 4, and the irradiation density may be varied depending on the location as dictated by the various objectives.

(B)

In the above embodiments, an example was described in which the laser irradiation was laser forming for reducing warpage of the thrust plate 4, but the present invention is not limited to this.

For instance, it may be laser marking. That is, as shown in FIG. 8A, a QR code 47 or other such identification code may be formed on the face 42 of the thrust plate 4. Numbers, logos, or other markings may also be used besides the QR code 47.

This laser marking is accomplished by utilizing the heat of the laser beam to change the color or reflectivity of the light in the laser irradiation region by subjecting the surface of a substance to baking (oxidation), peeling, etc.

Consequently, a code indicating the lot number of the thrust plate 4, for example, can be easily formed on the face 42 of the thrust plate 4 even after the assembly of the hydrodynamic bearing device. Also, since an identification code can be engraved without coming into contact with the thrust plate 4, no material is wasted and there is no need for ink or other such materials. Therefore, the throughput is higher in the manufacturing process, and cost can be curtailed.

Also, particularly when the QR code 47 is formed, because of the redundancy of the information contained in the QR code 47, even if part of the QR code 47 should become damaged or soiled and can no longer be read, that information can be recovered from another region. Therefore, even if the surface of the thrust plate 4 becomes soiled or scraped off, the identification code can be read at a higher probability than in the past.

As shown in FIG. 8B, the irradiation position of the QR code 47 may be offset from the center of the thrust plate 4.

(C)

In the above embodiments, an example was described in which the laser irradiated portion 43 included a plurality of laser spot irradiations, but the present invention is not limited to this.

For example, as shown in FIG. 9, the laser irradiated portion 43 may be formed by scanning a single laser irradiation in the desired length and shape.

Here again, it is possible to perform laser forming that corresponds to the shape of the warpage of the thrust plate 4, and to reduce this warpage.

(D)

In the above embodiments, an example was described in which the side end 45 of the thrust plate 4 was latched (crimped) by the latching portion 21 provided to the end of the sleeve 2 in the attachment of the thrust plate 4 to the sleeve 2, but the present invention is not limited to this.

For instance, the method for fixing the thrust plate may be one that involves adhesive bonding or press-fitting, or a combination of these, other than fixing by crimping.

(E)

In the above embodiments, an example was described in which the hydrodynamic groove 44 was formed in the face 41 of the thrust plate 4 opposite the thrust flange 3, but the present invention is not limited to this.

For instance, the hydrodynamic groove may be formed in the face on the opposing shaft side, rather than in the face on the thrust plate side.

Here again, warpage produced in the attachment of the thrust plate to the sleeve can be smoothed out by laser irradiation, or the flatness of the face on the shaft side can be adjusted, affording a hydrodynamic bearing device with higher reliability.

(F)

In the above embodiments, an example was described in which the diameter of the laser irradiated portion 43 was approximately 5 μm, but the present invention is not limited to this.

For instance, the diameter may be 10 μm or greater, or may be less than 5 μm. This can be adjusted by means of the spot diameter of the irradiating laser, and can also be adjusted by means of the distance between the laser generator and the thrust plate 4.

(G)

In the above embodiments, an example was described in which the pattern of the hydrodynamic groove 44 as seen from above was the herringbone pattern shown in FIG. 3A, but the present invention is not limited to this.

For instance, the hydrodynamic groove may be formed in a spiral shape or another such shape.

(H)

In the above embodiments, as shown in FIG. 2, an example was described in which the thrust plate 4 was directly attached to one end of the sleeve 2, but the present invention is not limited to this.

For instance, as shown in FIG. 10, a bracket 51 is provided on the outer peripheral face side of the sleeve 2, and the sleeve 2 is fitted into the bracket 51. The thrust plate 4 may be fixed by pressing it against one end of the sleeve 2 by means of a latching portion 52 provided to one end of the bracket 51.

(I)

In the above embodiments, an example was described in which the method for forming the hydrodynamic groove 44 was etching, but the present invention is not limited to this.

For instance, it may be formed by electrolytic working, electrolytic etching, or coining.

Here again, the same hydrodynamic groove as in the above embodiments can be formed.

(J)

In the above embodiments, an example was described in which the method for inspecting and measuring the warpage and unevenness of the thrust plate 4 was to use a laser focusing displacement gauge, but the present invention is not limited to this.

For instance, the method may be a non-contact measurement method that makes use of another optical or over-current system, or a measurement method that makes use of a contact-type step gauge or the like.

Each of these methods has its own strengths, depending on the extent of warpage, the size of the object being tested (the test surface area), and so forth. Therefore, the measurement method best suited to the object being tested can be selected. As a result, these various measurement methods allow warpage of the thrust plate 4 to be measured efficiently.

(K)

In the above embodiments, an example was described in which the inspection for warpage of the thrust plate 4 and the laser irradiation, that is, steps S4 and S5 in the manufacturing process, were carried out after the thrust plate 4 had been fixed to the sleeve 2, but the present invention is not limited to this.

For instance, the above-mentioned steps S4 and S5 may be performed before the thrust plate 4 has been fixed to the sleeve 2.

(L)

In the above embodiments, an example was described in which the step of forming a blank for the thrust plate 4 (step S1) was a step in which a material (SUS 420J2) was punched out in the shape of a disk with a press, but the present invention is not limited to this.

For instance, the material may be cut into the shape of a disk by a cutting method.

(M)

In the above embodiments, an example was described in which the inspection for warpage of the thrust plate 4 and the laser irradiation, that is, steps S4 and S5 in the manufacturing process, were carried out after the thrust plate 4 had been fixed to the sleeve 2, but the present invention is not limited to this.

For instance, a plurality of thrust plates 4 formed in the same mold usually have substantially the same tendency toward warping. Accordingly, when a plurality of thrust plates 4 are thus formed using a single mold (mass production), the inspection for warpage (step S4) is performed only for a specific number of thrust plates 4 (such as one) out of the plurality of thrust plates 4 that are formed (that is, sampling is performed). The rest of the thrust plates 4 may then undergo step S5, applying laser irradiation conditions based on the results of this sampling.

Consequently, when many thrust plates 4 are formed from the same mold, the number of inspections for warpage of the thrust plates 4 can be reduced. Therefore, thrust plates 4 with reduced warpage can be mass produced more efficiently.

(N)

In the above embodiments, an example was described in which the laser spot irradiation conditions included an output of the semiconductor laser that generates the laser beam of 3800 W (a voltage of 200 V and a current of 19 A), and a spot diameter of 5 μm on the surface of the thrust plate 4, and an irradiation time of 0.004 second per spot, but the present invention is not limited to this, and the laser irradiated portion 43 may be formed under other irradiation conditions.

(O)

In the above embodiments, an example was described of a hydrodynamic bearing device (the bearing 7) mounted in a rotating shaft type of spindle motor 8, but the present invention is not limited to this.

For instance, the present invention may also be applied to a hydrodynamic bearing device mounted in a stationary shaft type of spindle motor.

(P)

In the above embodiments, an example was described in which the HDD 9 served as an information apparatus including a spindle motor equipped with the hydrodynamic bearing device pertaining to the present invention, but the present invention is not limited to this.

For instance, the present invention can, of course, be applied to other kinds of information apparatus, such as an magneto-optical disk apparatus, an optical disk apparatus, a Floppy (registered trademark) disk apparatus, a rotary head apparatus used in a data streamer or a video cassette recorder, or a polygon motor device used in a laser scanner, a laser printer, or the like.

(Q)

In the above other embodiment (B), an example was described in which the identification code produced by laser marking was QR code, but the present invention is not limited to this.

For instance, it may be Code 49, Code 16K, PDF417, Ultra Code, Data Matrix, Veri Code, Maxi Code, CP Code, Code 1, Box Graphic Code, Aztech Code, or another such two-dimensional code. Also, as shown in FIG. 11A, it may be JAN, ITF, Code 39, NW-7, or Code 128, or another such barcode. As shown in FIG. 11B, the position of the identification code may be offset toward the end of the thrust plate 4.

Consequently, just as in the other embodiment (B) above, a code expressing the lot number of the thrust plate 4 can be easily formed on the face 42 of the thrust plate 4 even after the assembly of the hydrodynamic bearing device. Also, since an identification code can be engraved without coming into contact with the thrust plate 4, no material is wasted and there is no need for ink or other such materials. Therefore, the throughput is higher in the manufacturing process, and cost can be curtailed.

(R)

In the above embodiments, an example was described in which the spot irradiation positions were within a substantially circular region near the center of the thrust plate 4, but the present invention is not limited to this.

For instance, the spot irradiations may be performed in a substantially square shape (see FIG. 12), or within another polygonal region.

This will have the same effects as the above embodiments.

### INDUSTRIAL APPLICABILITY

The method for manufacturing a thrust plate pertaining to the present invention has the effect of allowing the thrust plate to be made smooth even after assembly into a hydrodynamic bearing device, and can therefore not only be applied as a method for manufacturing a thrust plate, but also applied more broadly as a method for working members that undergo deformation in the course of manufacture.

### BRIEF DESCRIPTION OF DRAWINGS

FIG. 1 is a side view cross section of the main portions inside the HDD pertaining to an embodiment of the present invention;

FIG. 2 is a side view cross section of the bearing (hydrodynamic bearing device) mounted in the HDD of FIG. 1;

FIG. 3A is a top plan view of a thrust plate provided to the bearing in FIG. 2, and

FIG. 3B is a bottom plan view of a thrust plate provided to the bearing in FIG. 2;

FIG. 4 is a flowchart of the manufacturing process for the thrust plate pertaining to this embodiment;

FIG. 5A is a diagram of the state prior to the crimping of the thrust plate in step S3 of the manufacturing process shown in FIG. 4, and FIG. 5B is a diagram of the state after the crimping of the thrust plate in step S3 of the manufacturing process shown in FIG. 4;

FIG. 6 is a side view of the thrust plate after step S3 in the manufacturing process shown in FIG. 4;

FIG. 7A is a diagram of the corresponding relationship between warpage of the thrust plate and the laser irradiation position when local warpage occurs in the thrust plate pertaining to another embodiment of the present invention, and FIG. 7B is a diagram of the corresponding relationship between warpage of the thrust plate and the laser irradiation position when the center of the warpage of the thrust plate is offset;

FIG. 8A is a bottom plan view of the thrust plate pertaining to another embodiment of the present invention, and FIG. 8B is also a bottom plan view of the thrust plate pertaining to another embodiment of the present invention;

FIG. 9 is a bottom plan view of the thrust plate pertaining to another embodiment of the present invention;

FIG. 10 is a side cross section of the hydrodynamic bearing device pertaining to another embodiment of the present invention;

FIG. 11A is a bottom plan view of the thrust plate pertaining to another embodiment of the present invention, and FIG. 11B is also a bottom plan view of the thrust plate pertaining to another embodiment of the present invention; and

FIG. 12 is a bottom plan view of the thrust plate pertaining to another embodiment of the present invention.

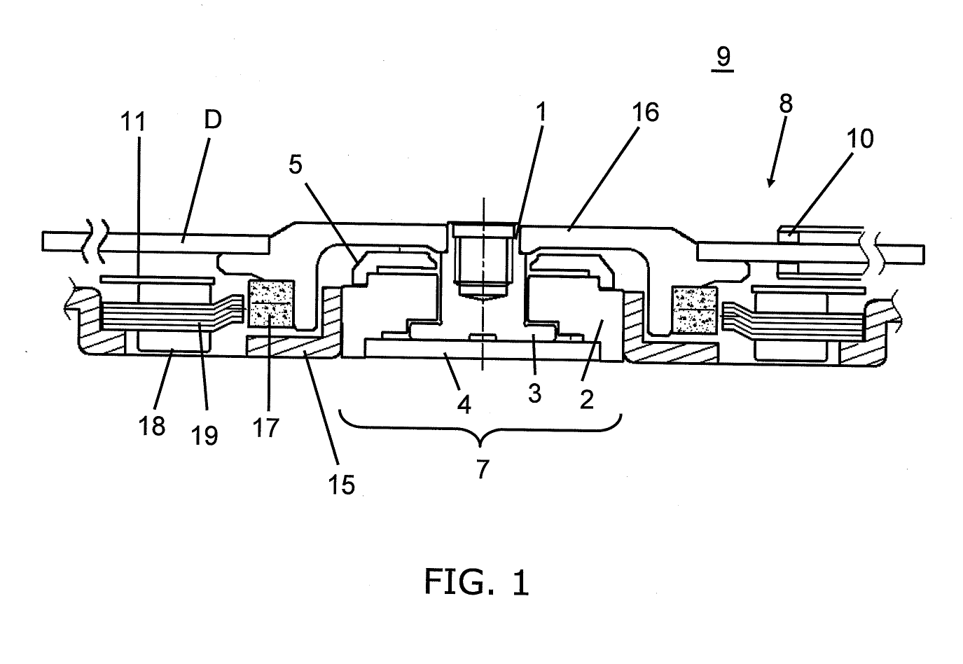

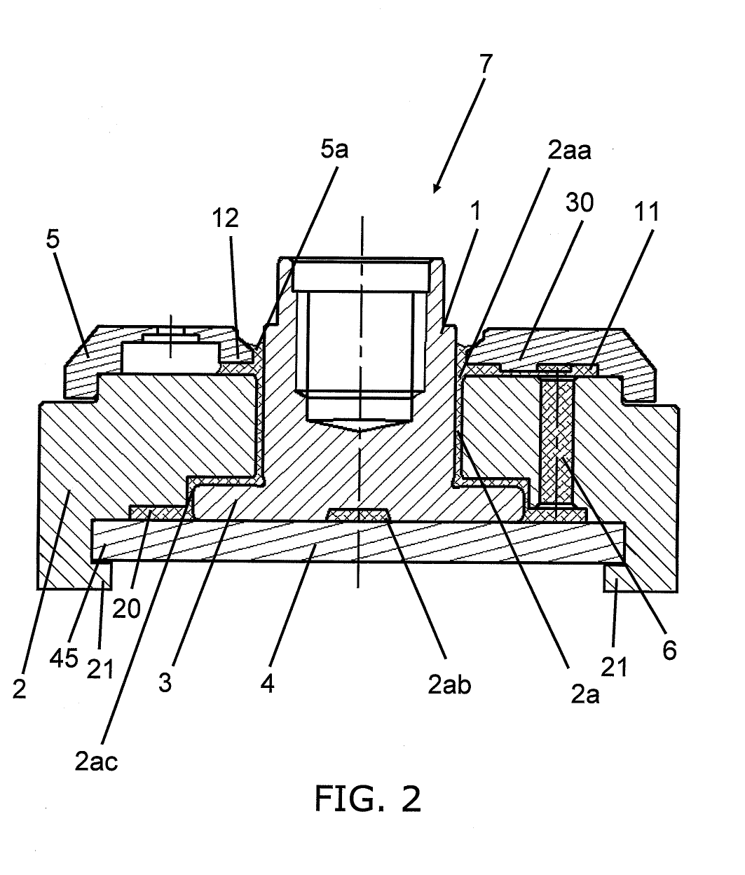

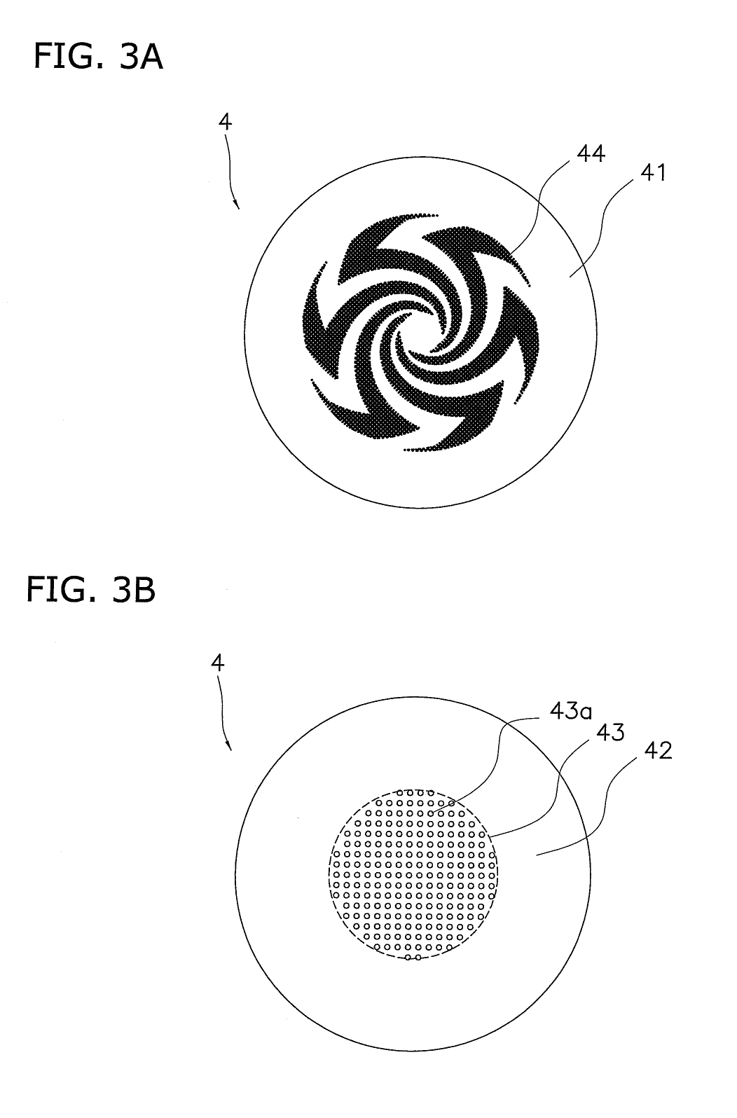

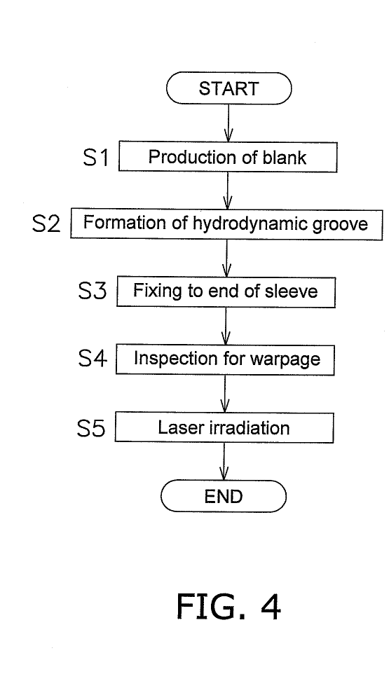

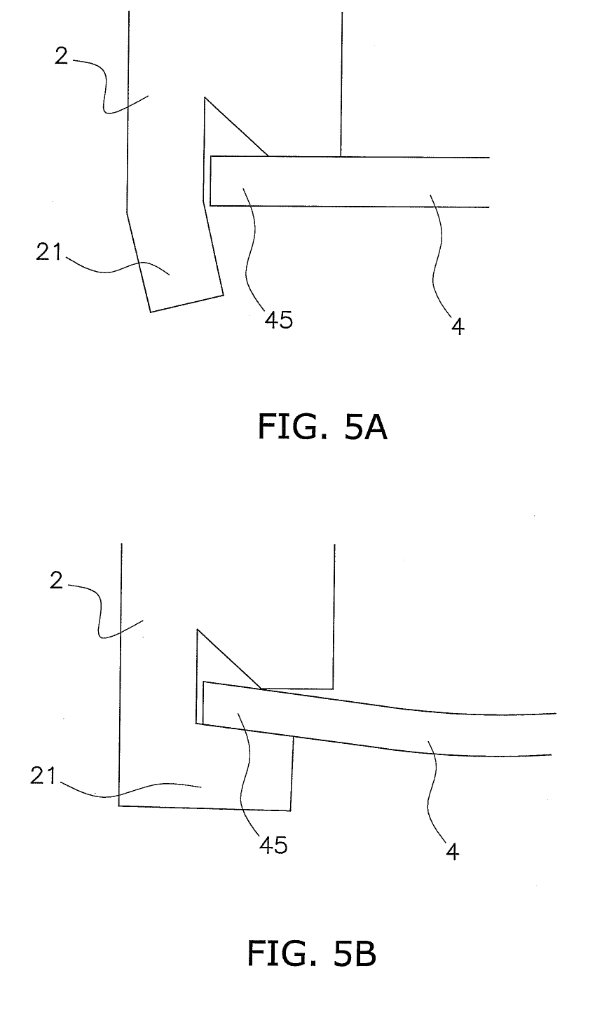

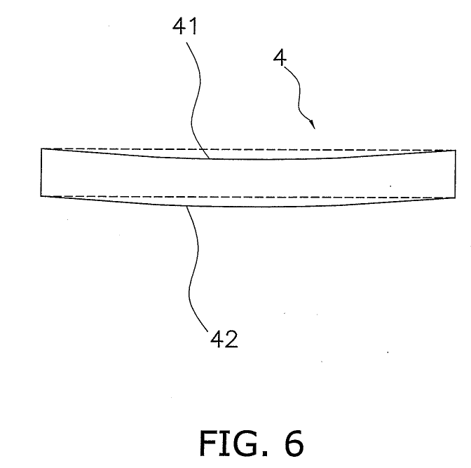

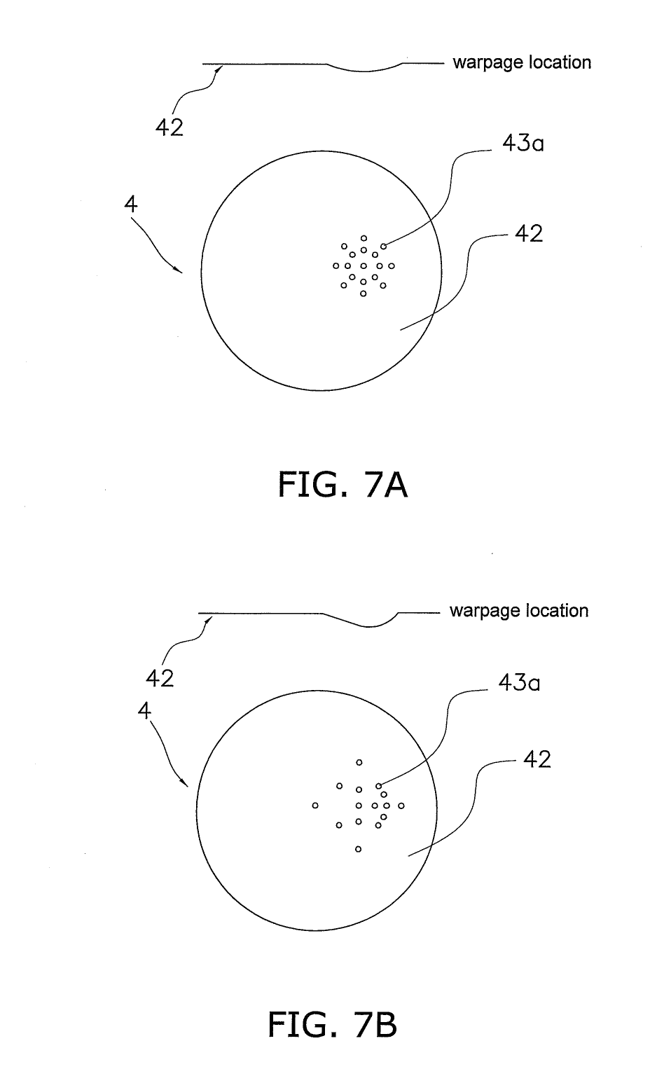

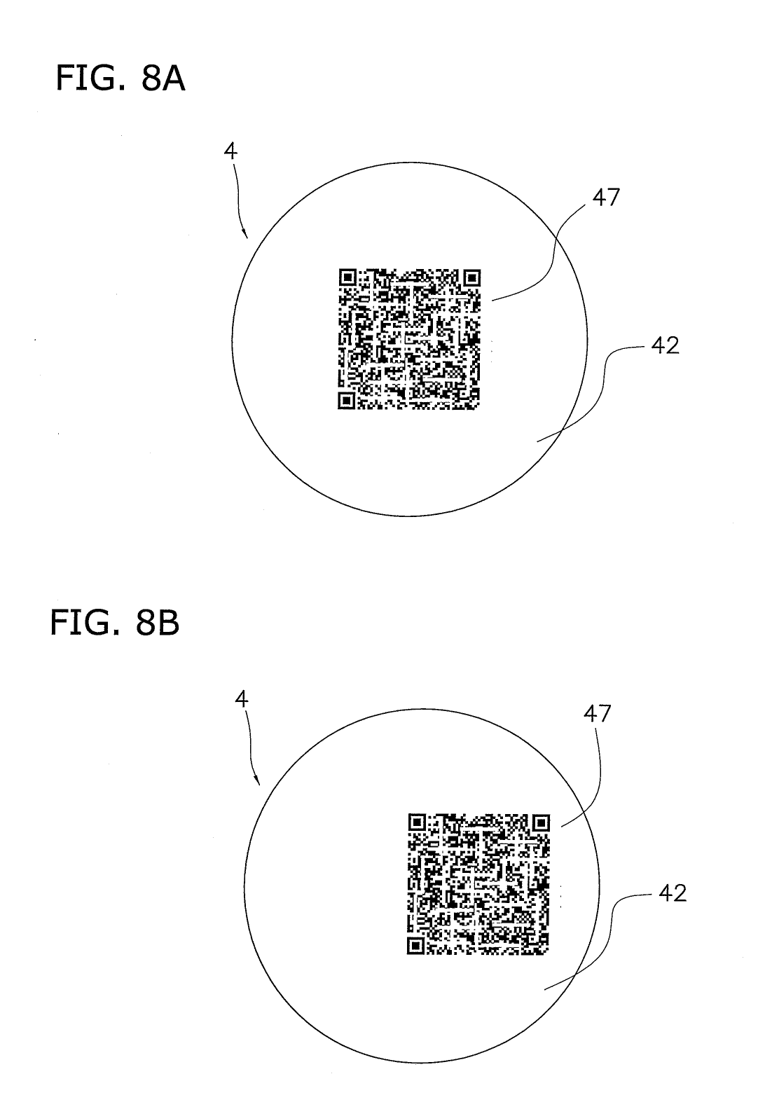

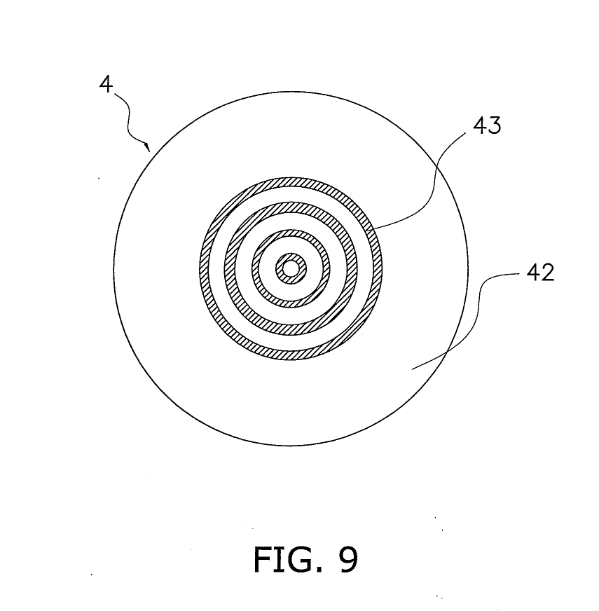

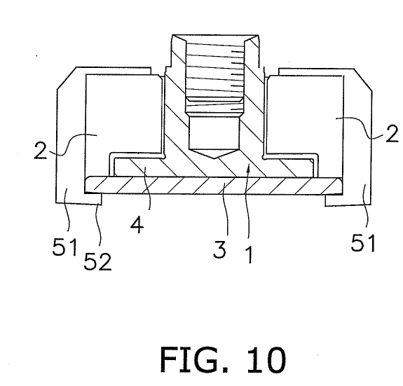

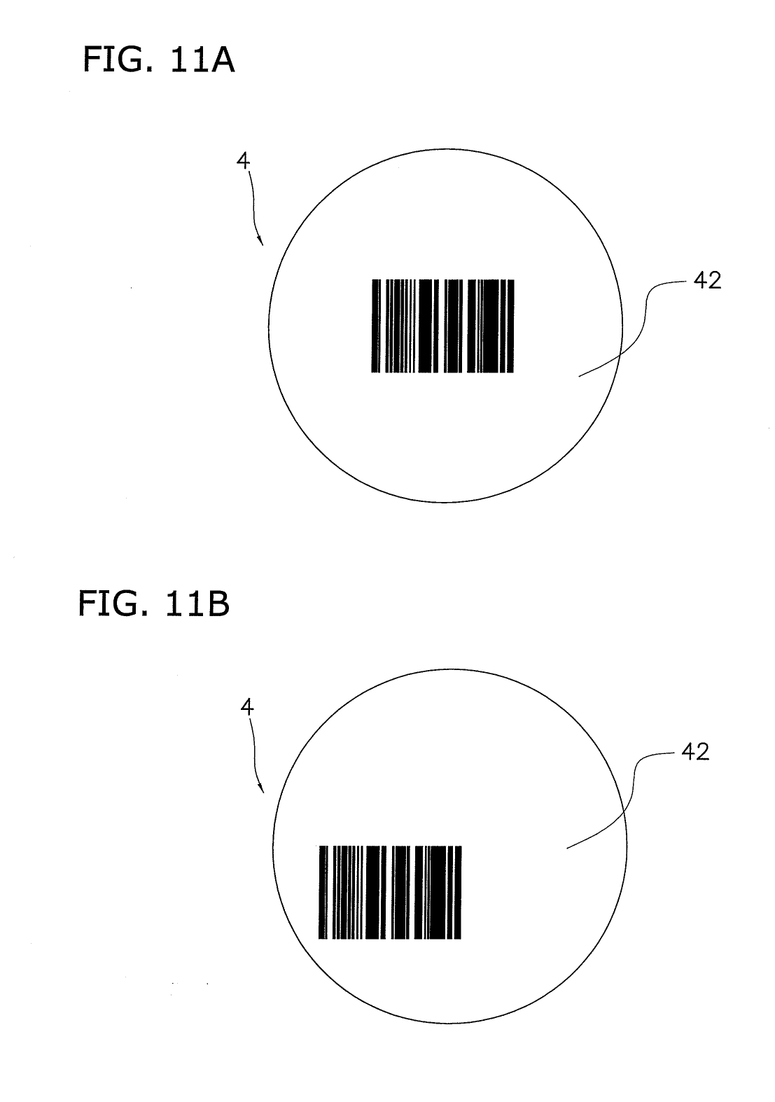

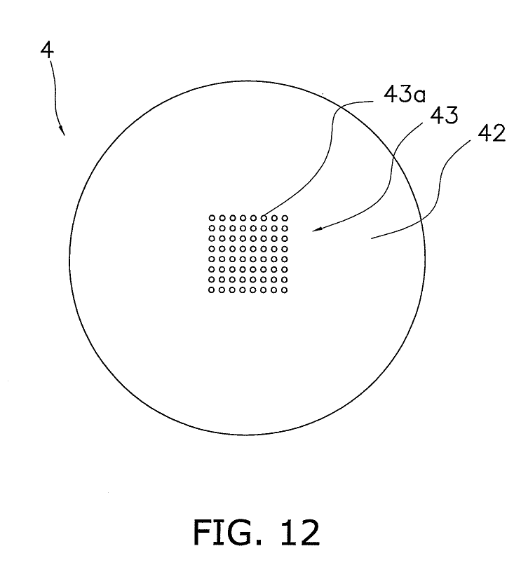

### KEY

1 shaft
2 sleeve
2a bearing hole
2aa open end
2ab closed end
2ac large-diameter portion
3 thrust flange
4 thrust plate
5 cover
5a inner peripheral opening
6 communicating hole
7 bearing (hydrodynamic bearing device)
8 spindle motor
9 HDD (information apparatus)
10 recording and reproducing head
11 magnetic shield plate
12 inner peripheral seal
15 base
16 rotor hub
17 rotor magnet
18 stator coil
19 stator core
20 lubricating fluid (oil)
21 latching portion
41 face (face on shaft side)
42 face
43 laser irradiated portion
43a spot irradiated portion
44 hydrodynamic groove
44a recessed portion
45 side end
47 QR code
51 bracket
52 latching portion

1. A thrust plate included in a hydrodynamic bearing device,
the thrust plate having a laser irradiated portion that is provided at one end of a shaft included in the hydrodynamic bearing device and substantially perpendicular to the axial direction of the shaft, and that is irradiated with a laser on the opposite side from the side facing the shaft.

2. The thrust plate according to claim 1,
wherein the laser irradiated portion is formed by a plurality of spot irradiations of the laser.

3. The thrust plate according to claim 1,
wherein the laser irradiated portion is provided substantially in the center.

4. The thrust plate according to claim 1,
wherein the laser irradiated portion is formed as an identification code.

5. The thrust plate according to claim 4,
wherein the identification code is a QR code.

6. A hydrodynamic bearing device equipped with the thrust plate according to claim 1.

7. A spindle motor equipped with the hydrodynamic bearing device according to claim 6.

8. An information apparatus equipped with the spindle motor according to claim 7.

9. A method for manufacturing a thrust plate that is provided at one end of a shaft included in a hydrodynamic bearing device and substantially perpendicular to the axial direction of the shaft, said method having:
a first step of inspecting the state of warpage of the thrust plate; and
a second step of irradiating with a laser a position corresponding to the warpage, which was ascertained in the first step, on the opposite side of the thrust plate from the side facing the shaft.

10. The method for manufacturing a thrust plate according to claim 9, wherein the laser irradiation is performed by a plurality of spot irradiations in the second step.

11. The method for manufacturing a thrust plate according to claim 9,
wherein control is performed in the second step by at least one of the output of the laser, the spot diameter of the laser, and the irradiation time of the laser.

12. The thrust plate according to claim 2,
wherein the laser irradiated portion is provided substantially in the center.

13. The thrust plate according to claim 2,
wherein the laser irradiated portion is formed as an identification code.

14. The thrust plate according to claim 3,
wherein the laser irradiated portion is formed as an identification code.

15. A hydrodynamic bearing device equipped with the thrust plate according to claim 2.

16. A hydrodynamic bearing device equipped with the thrust plate according to claim 3.

17. A hydrodynamic bearing device equipped with the thrust plate according to claim 4.

18. A hydrodynamic bearing device equipped with the thrust plate according to claim 5.

19. The method for manufacturing a thrust plate according to claim 10,
wherein control is performed in the second step by at least one of the output of the laser, the spot diameter of the laser, and the irradiation time of the laser.
